(19) United States
(12) Patent Application Publication
(10) Pub. No.: US 2022/0309599 A1
(43) Pub. Date: Sep. 29, 2022

(54) SYSTEM AND METHOD FOR AUTHORIZING TRANSFER REQUESTS OF PHYSICAL LOCATIONS

(71) Applicant: Toby Michael Cohen, New York, NY (US)

(72) Inventor: Toby Michael Cohen, New York, NY (US)

(21) Appl. No.: 17/841,209

(22) Filed: Jun. 15, 2022

Related U.S. Application Data
(63) Continuation of application No. 17/559,416, filed on Dec. 22, 2021.
(60) Provisional application No. 63/131,645, filed on Dec. 29, 2020.

(51) Int. Cl. G06Q 50/16; G06F 16/9537; G06F 16/93; G06Q 10/06

(52) U.S. Cl. CPC G06Q 50/16; G06F 16/9537; G06F 16/93; G06Q 10/0637

(57) ABSTRACT

Systems and method are provided for securing physical-location transfers that include receiving object information associated with a particular physical location; receiving user information associated with a user that owns the physical location; generating a protected object associated with the physical location, wherein the protected object is generated based on the object information and the user information; generating a user key associated with the physical location, wherein generating the user key is based on the object information and the user information; storing the user key and a physical-location identifier associated with the physical location in a database; receiving a transfer request associated with the physical location, the transfer request including the user key; transmitting an authorization request for the transfer associated with the physical location; and receiving one of an authorization for the transfer associated with the physical location and a cancellation for the transfer associated with the physical location.

### CROSS REFERENCE TO RELATED APPLICATIONS

This application is a continuation of U.S. patent application Ser. No. 17/559,416 filed Dec. 22, 2021, which claims the benefit of U.S. Provisional Patent Application No. 63/131,645 filed on Dec. 29, 2020, both of which are hereby incorporated by reference in their entirety for all purposes.

### TECHNICAL FIELD

This disclosure relates generally preventing unauthorized access to secured systems, and more particular to securing data reads and writes to secured systems to prevent unauthorized transfers associated with physical locations.

### BACKGROUND

Conventionally, objects (e.g., documents, documentation, datasets, data structures, etc.) associated with a transfer of ownership of a physical location (e.g., real property) from a first user were analyzed in a central location. However, this is no longer the case. Although this brings conveniences, it has also resulted in an increase in unauthorized transfers and/or transfer requests of physical locations. As an example, an unauthorized user may cause the first user to transfer the physical location under false pretenses or by forging a transfer objects or signatures of the first users. In most areas, it is possible to record objects associated with a transfer as long as the objects are signed, dated, and notarized.

It is with these issues in mind, among others, that various aspects of the disclosure were conceived.

### SUMMARY

Methods are described herein for securing transfers associated with physical locations. The methods can include receiving, by at least one processor, object information associated with a particular physical location; receiving, by the at least one processor, user information associated with a user that owns the physical location; generating, by the at least one processor, a protected object associated with the physical location, wherein the protected object is generated based on the object information and the user information; generating, by the at least one processor, a user key associated with the physical location, wherein generating the user key is based on the object information and the user information; storing, by the at least one processor, the user key and a physical-location identifier associated with the physical location in a database; receiving, by the at least one processor, a transfer request associated with the physical location, the transfer request including the user key; transmitting, by the at least one processor, an authorization request for the transfer associated with the physical location; and receiving, by the at least one processor, one of an authorization for the transfer associated with the physical location and a cancellation for the transfer associated with the physical location.

Systems are described herein for securing transfers associated with physical locations. The systems include one or more processors and a non-transitory computer-readable medium storing instructions that, when executed by the one or more processors, cause the one or more processors to perform any of the methods as previously described.

A non-transitory computer-readable media described herein may store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawing.

FIG. 1 is a block diagram of an example system for authorizing physical location transfers according to aspects of the present disclosure.

FIGS. 2-19 illustrates example screenshots associated with a graphical user interface of the system for authorizing physical location transfers according to aspects of the present disclosure.

FIG. 20 illustrates a flowchart of an example process for authorizing a physical location transfer according to aspects of the present disclosure.

FIG. 21 illustrates a flowchart of another example process for authorizing a physical location transfer according to aspects of the present disclosure.

FIG. 22 illustrates an example computing device architecture of an example computing device that can implement the various techniques described herein according to aspects of the present disclosure.

### DETAILED DESCRIPTION

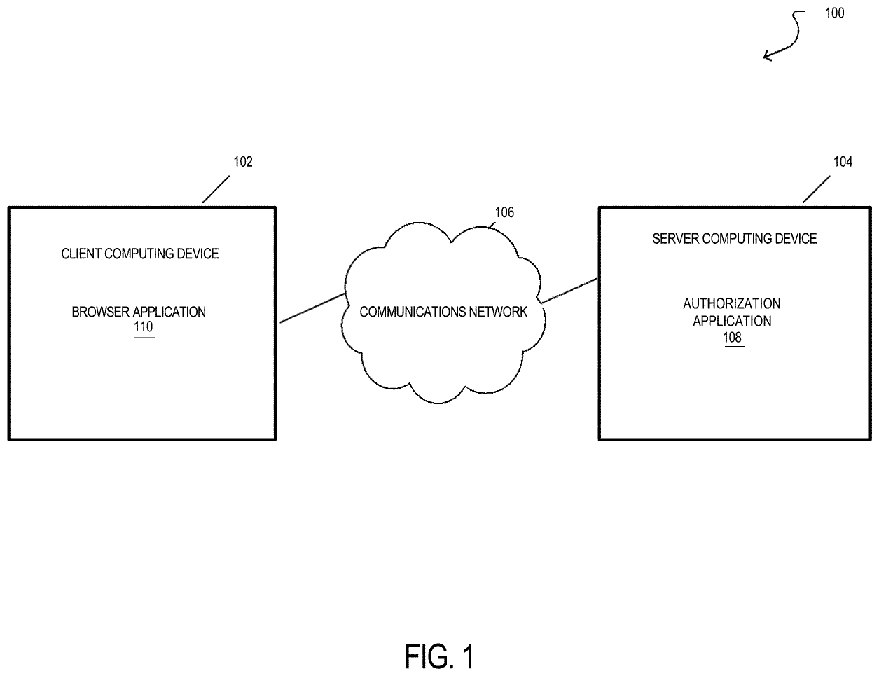

FIG. 1 is a block diagram of an example system for authorizing physical location transfers according to aspects of the present disclosure. The system 100 may include a plurality of computing devices such as a client computing device 102 and a server computing device 104 that communicate via a communication network 106. The server computing device 104 may be one or more computing devices, a virtual machine, a container, or another type of packager that may be capable of executing one or more programs or applications. The client computing device 102 may execute a browser application 110 using at least one processor and the server computing device 104 may execute an authorization application 108 using at least one processor. As an example, the authorization application 108 may transmit a graphical user interface (GUI), data, and information to the browser application 110 of the client computing device 102. The client computing device 102 may display the GUI associated with the authorization application 108 using the browser application 110 and may transmit data and information to the server computing device 104 using the communication network 106.

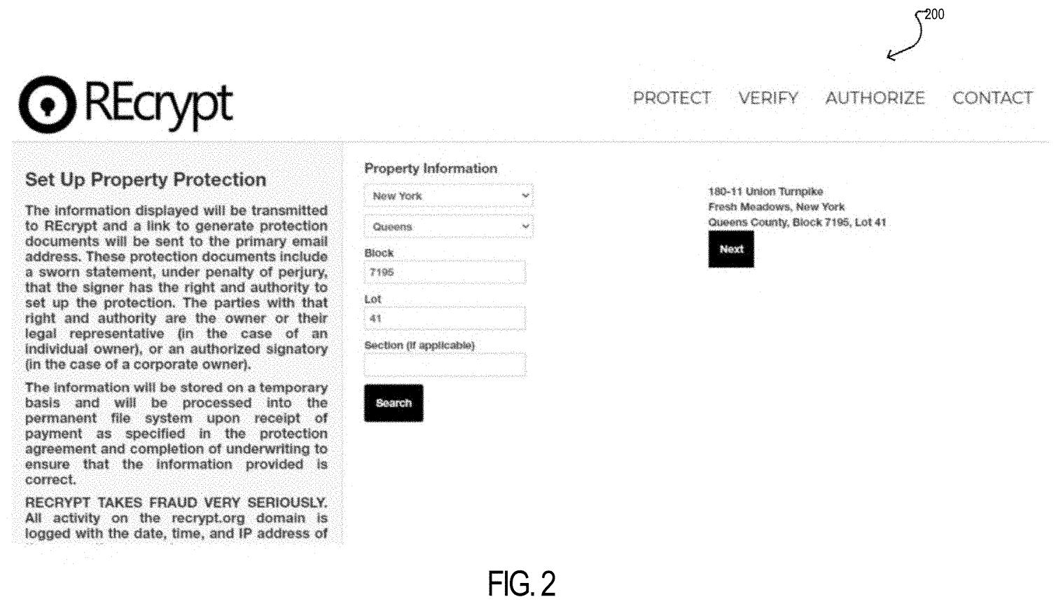

FIGS. 2-19 illustrates example screenshots associated with a graphical user interface of the system for authorizing physical location transfers according to aspects of the present disclosure.

FIG. 2 illustrates a screenshot 200 of an example graphical user interface according to an example of the instant disclosure. As shown in FIG. 2, the authorization application 108 may be used to establish protection (e.g., protected objects, and/or the like) for a particular physical location (e.g., piece of real property, etc.). A user (e.g., the owner of the physical location, a user associated with the owner, or the like) of the client computing device 102 may enter information associated with the physical location such as state information by selecting a state of the United States and by selecting a county located in the selected state, as well as providing block information, lot information, and section information, among other information. The client computing device 102 may transmit the information to the authorization application 108 and the authorization application 108 may query a database to determine a physical address. The physical address may be displayed by the client computing device 102. This may indicate that the physical location is protected or is not protected by the system 100.

In some instances, a physical location may be protected by a protected object (e.g., protection documentation, protection dataset, and/or the like). While present, the protected object may prevent a transfer (e.g., a transaction, etc.) associated with the physical location. The protected object may be stored in a one or more databases (on digital and/or physical form) in association with the physical location and/or information derived from the physical location. A database of the one or more databases may be associated with or managed by the server computing device 104, the client computing device 102, an independent computing device (e.g., a title service, a recorder associated with a particular state or geographical area, and/or the like). Authorizing and/or executing a transfer may include determining if a protected object exists in association with a particular physical location and terminating the protected object.

The protected object can be associated with a protected time interval that corresponds to the time between generating the protected object and terminating the protected object. In some instances, the protected object may be generated by a user at any time after ownership of the physical location is recorded. The user may request termination of the protected object prior to or during a transfer of the physical location to a new user.

A recorded object (e.g., information linking the current user of the physical location to the physical location, etc.) may be stored at a location of the recorder. The recorded object may include a reference to the protected object (such that transfers of the physical location are can be prevented) and/or a reference a file record that is stored by or in association with server computing device 104. The file record may include an identification of the physical location, the current user of the physical location, characteristics of the physical location, characteristics of the user, a reference to various objects (authorization objects, protected objects, etc.), instances of one or more of the various object, combinations thereof, or the like. The reference to the file record may link the protected period of the physical location to database of server computing device 104. The reference may include a link (e.g., such as a unform resource locator, etc.), an identifier of the file record, a pointer, combinations thereof, or the like.

The reference to the file record may be usable by a user or system attempting to access information associated with the physical location, the current user of the physical location, and/or the protected object at the location of the recorder to access additional information about the protected status of the physical location or the current user of the physical location. For example, the reference to the file record may indicate the presence of the protected object, the protected period, etc. Alternatively, or additionally, upon a user or system attempting to access information associated with the physical location, the current user of the physical location, and/or the protected object, the reference may trigger an notification that can be transmitted to server computing device 104, client device 102, a device associated with server computing device 104, a device associated with client device 102, and/or the like. The notification may alert the current user that an attempt to access information associated with the physical location has been made. In some instances, the server computing device 104, the client computing device 102, and/or the device that received the notification may be determined whether such a request to access information associated with a physical location protected by a protected object should be authorized. If authorization is granted the information can be distributed by the recorder. If authorization is denied, then the information may not be distributed.

A protected object may be terminated or otherwise deleted using information used to generate the protected object. For instance, the user of a physical location may generate a dataset from which a protected object may be generated. The dataset may include, but is not limited to, user information, physical-location identifier, physical-location information (e.g., physical address, markers, coordinates, etc.), historical transfer information (e.g., indicating how the user obtained the physical address), signatories (e.g., the user, a notary, others associated with the historical transfers or a current transfer, etc.), combinations thereof, or the like. The protected object may be derived from the dataset. In some instances, a user key may be also be generated with or from the object. The user key may be a single-use alphanumeric string that can be used to verify that the user intending to modify or terminate a protected object is the user that generated or facilitated the generation of the protected object. In some examples, the user key may be generated by executing a cryptographic hashing function (e.g., MD-5, SHA-3, etc.) on the dataset. The user may transmit a request to terminate a protected object along with the user key. Upon verifying the user key, the protected object may be terminated.

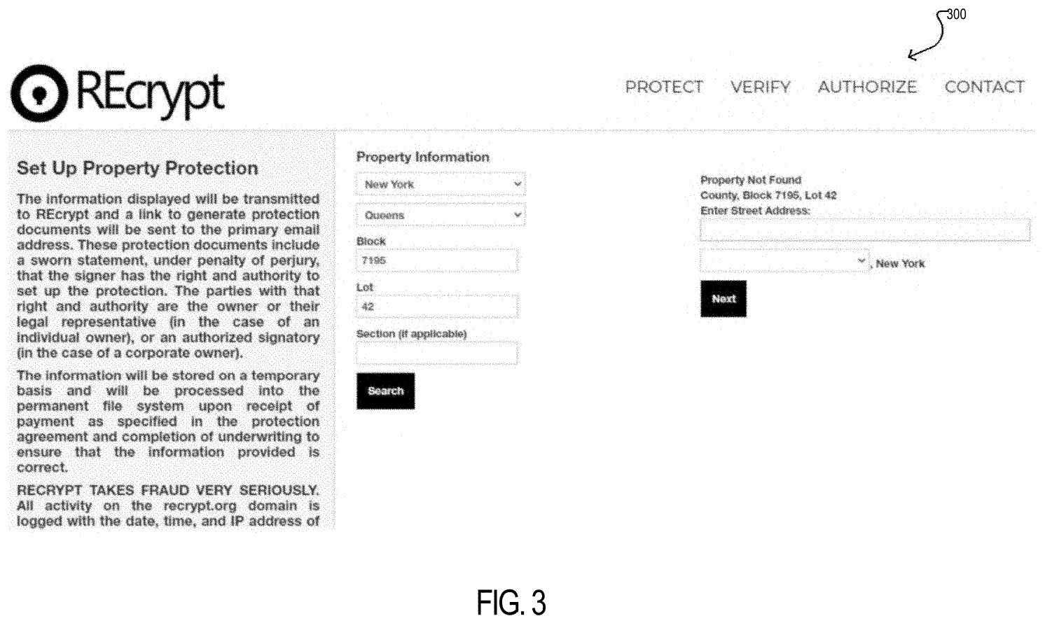

FIG. 3 illustrates a screenshot 300 of an example graphical user interface according to an example of the present disclosure. As shown in FIG. 3, the user may enter the information associated with the particular physical location. In this case, the particular physical location may not be protected by the system 100 as indicated by the graphical user interface.

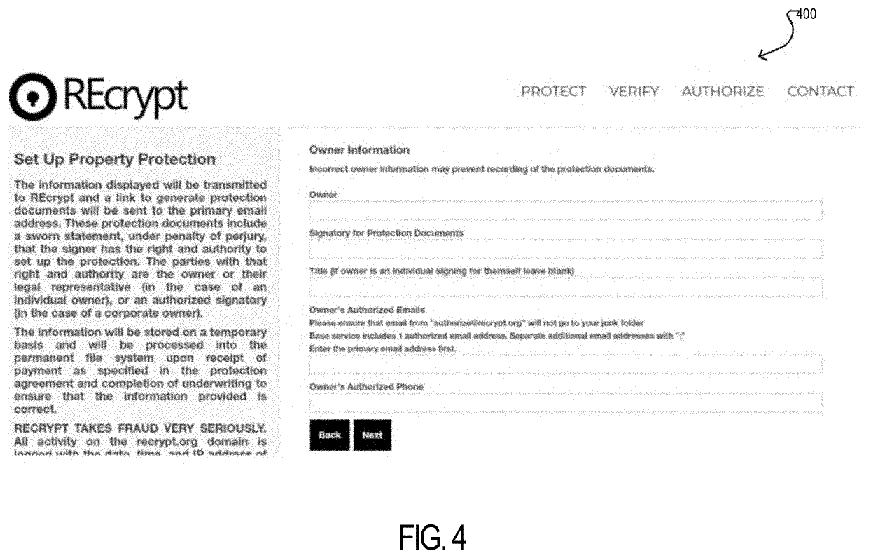

FIG. 4 illustrates a screenshot 400 of an example graphical user interface according to an example of the present disclosure. After determining that the physical location is not protected by the system 100, the user of the client computing device 102 may request to protect the physical location using the system 100. The user may provide user information such as a name of the owner of the physical location, at least one signatory for protected objects, a title of the user of the physical location, at least one communication address (e.g., email, Internet Protocol, physical address, etc.) associated with the user of the physical location, and at least one alphanumeric connection identifier (e.g., phone number, etc.) associated with the user of the physical location. The user may select the “Next” user interface element to set up physical location protection and transmit the information to the server computing device 104.

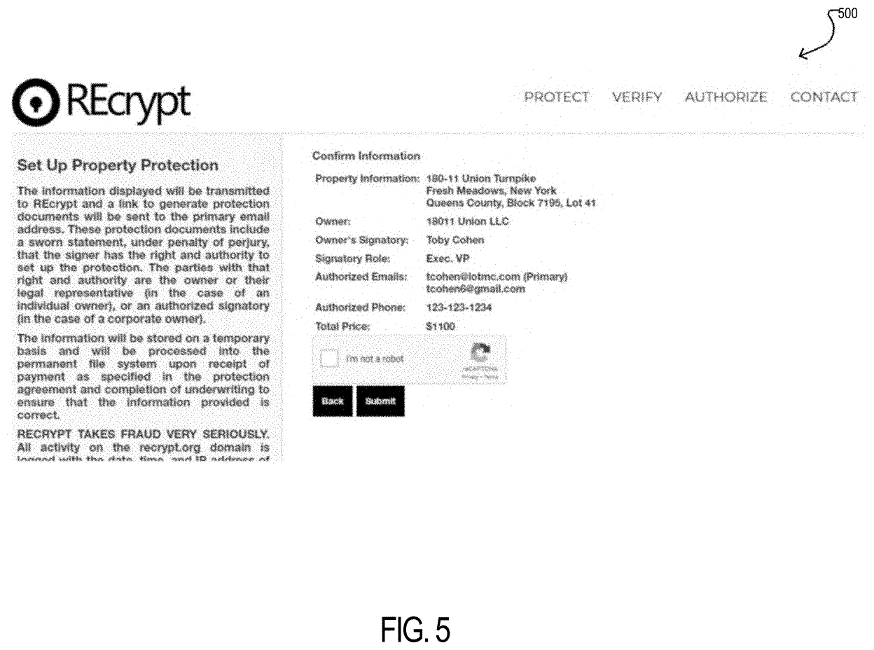

FIG. 5 illustrates a screenshot 500 of an example graphical user interface according to an example of the present disclosure. As shown in FIG. 5, the server computing device 104 receives the information, displays the information on the display of the client computing device 102, and requests that the user confirm the information. In some instances, a user interface element may be included to verify the identity of the user. For example, the user interface element may request a user key, password, or other identifier assigned to the user. In another example, a CAPTCHA (“Completely Automated Public Turing Test to Tell Computers and Humans Apart”, reCAPTCHA, and/or other process may be performed to ensure that the user is human (e.g., rather than an automated service).

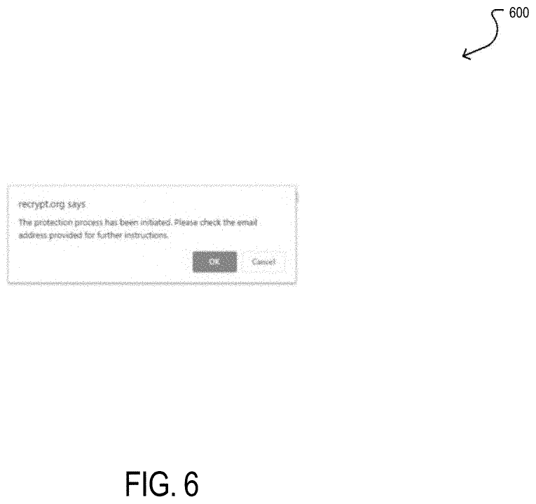

FIG. 6 illustrates a screenshot 600 of an example graphical user interface according to an example of the instant disclosure. As shown in FIG. 6, a modal user interface element or another display element may display information that indicates that a protection process has been initiated for the physical location. The server computing device 104 may transmit one or more communications to the communication addresses associated with the user of the physical location.

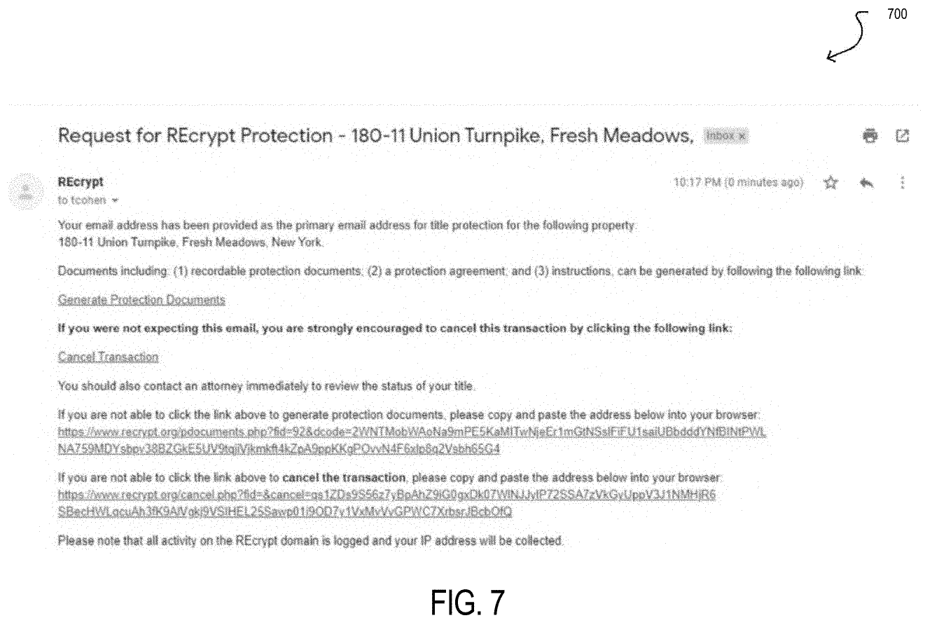

FIG. 7 illustrates a screenshot 700 of an example graphical user interface according to an example of the present disclosure. FIG. 7 shows an example of an a communication transmitted to one of the communication addresses associated with the user of the particular physical location. The user may select a uniform resource locator (URL) to one of generate protected objects and cancel the transfer request. The protected objects may be provided to a second user (e.g., title agent, etc.), or another recipient associated with the transfer request of the physical location.

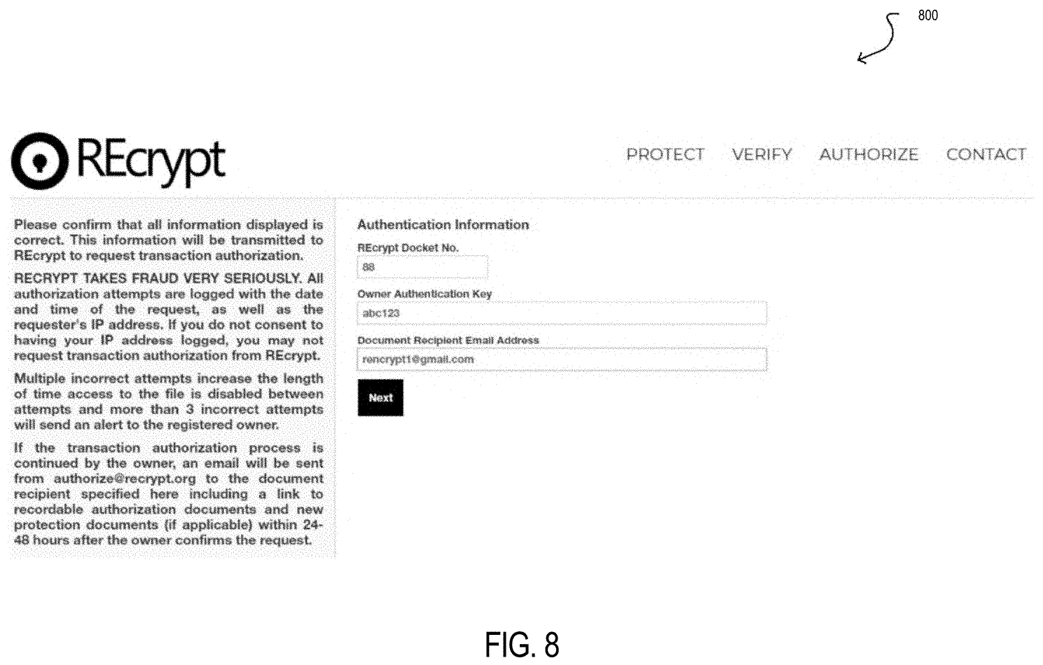

FIG. 8 illustrates a screenshot 800 of an example graphical user interface according to an example of the present disclosure. As shown in FIG. 8, after the user has generated a protected object (e.g., protection documents and/or documentation) associated with the physical location, at a later time, the user may desire to transfer ownership (e.g., by giving, selling, etc.) of the physical location, reassess a resource allocation (e.g., mortgage, etc.) associated with the physical location, or perform another action associated with the physical location. The user may provide an identifier (e.g., docket number) or physical-location identifier, a user key, and an object recipient communication address (e.g., such as an email address, Internet Protocol address, physical address, etc. associated with a user who is to receive the objects associated with the transfer), among other information. The client computing device 102 may transmit the information to the server computing device 104.

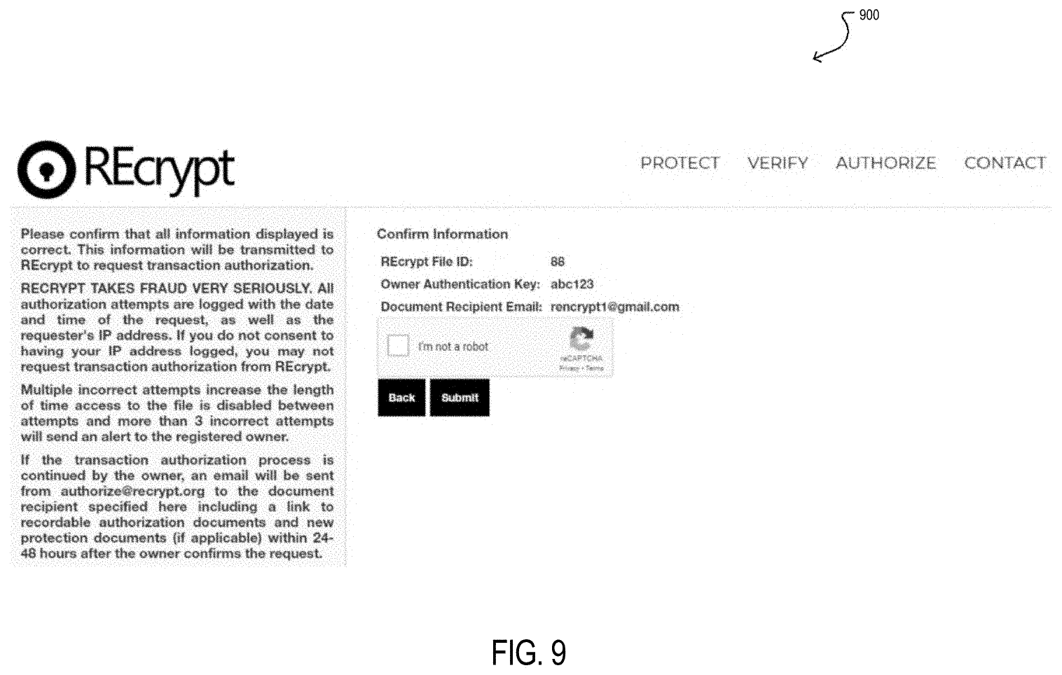

FIG. 9 illustrates a screenshot 900 of an example graphical user interface according to an example of the instant disclosure. As shown in FIG. 9, the server computing device 104 may receive the information and display the physical-location identifier, user key, and the object recipient communication address, among other information, on the display of the client computing device 102 for confirmation by the user.

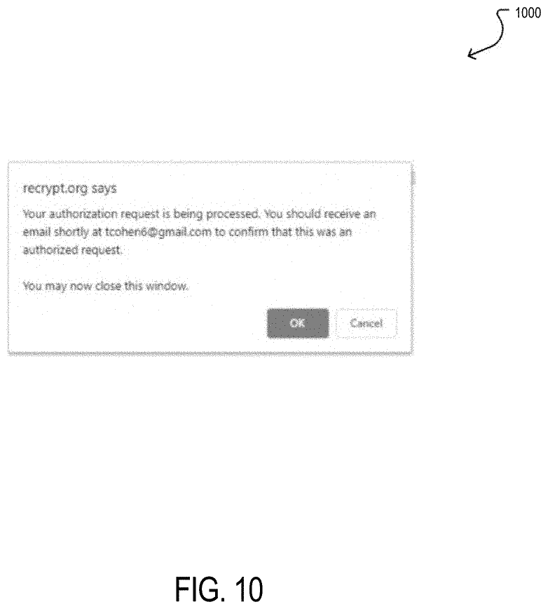

FIG. 10 illustrates a screenshot 1000 of an example graphical user interface according to an example of the instant disclosure. As shown in FIG. 10, after the user confirms the information, the server computing device 104 may begin the authorization request process. If the physical-location identifier and the user key are valid, the server computing device 104 may transmit a communication to the object recipient communication address.

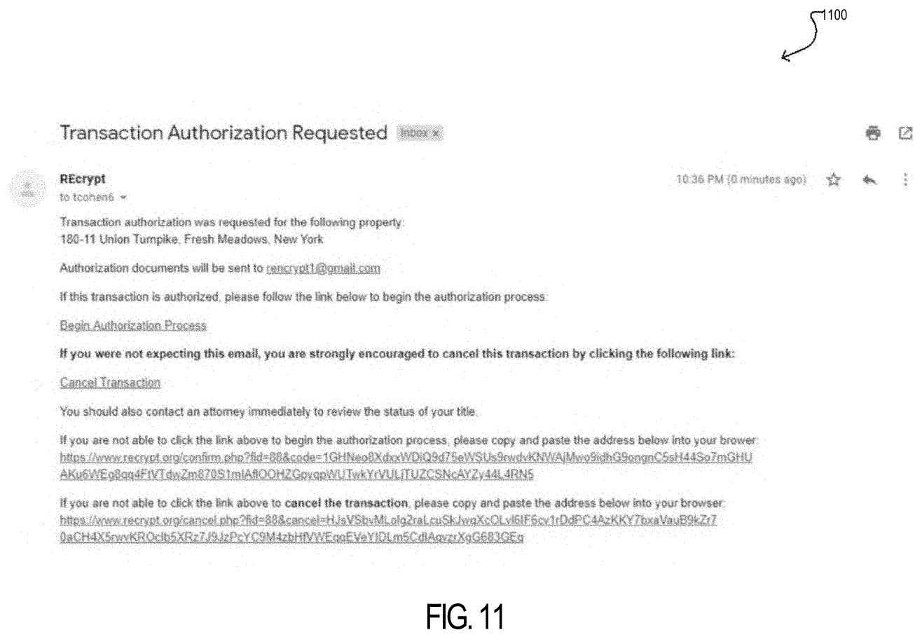

FIG. 11 illustrates a screenshot 1100 of an example graphical user interface according to an example of the instant disclosure. As shown in FIG. 11, the communication may be transmitted to the object recipient communication address. The user may select a uniform resource locator (URL) to begin the authorization process or may select another uniform resource locator (URL) to cancel the transfer.

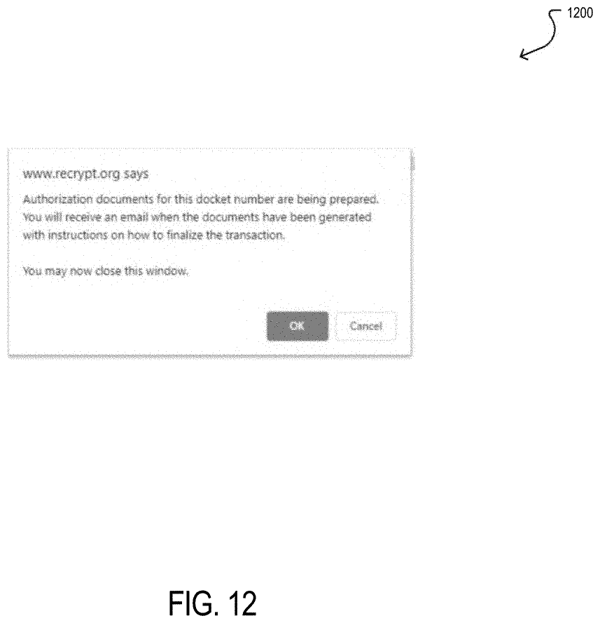

FIG. 12 illustrates a screenshot 1200 of an example graphical user interface according to an example of the instant disclosure. As shown in FIG. 12, upon executing the URL to begin the authorization process, the client computing device 102 may display a modal user interface element or another type of user interface element that indicates that authorization documents are being prepared by the server computing device 104.

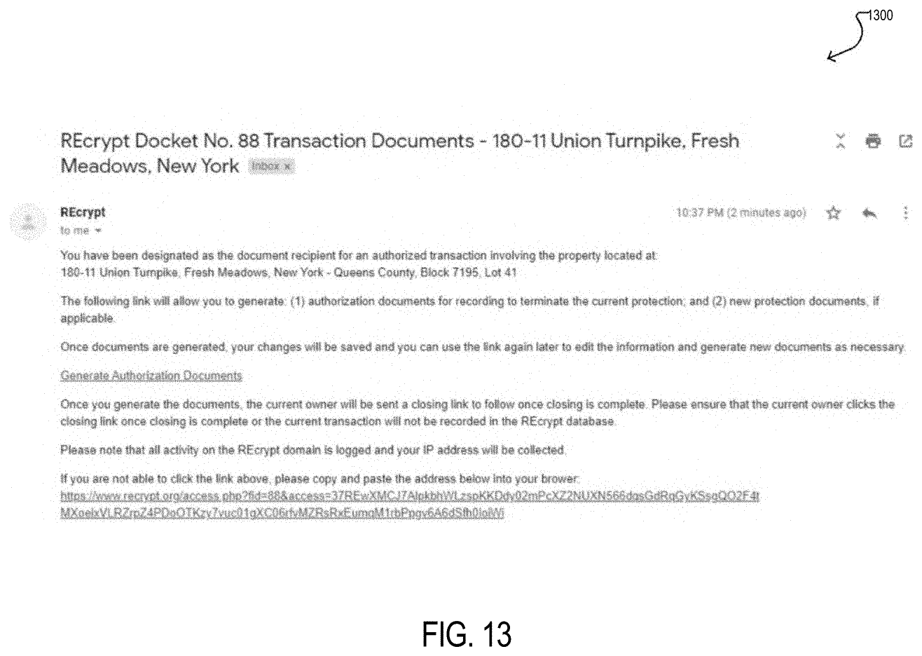

FIG. 13 illustrates a screenshot 1300 of an example graphical user interface according to an example of the instant disclosure. As shown in FIG. 13, upon executing the URL to begin the authorization process, the server computing device 104 may transmit another communication with a uniform resource locator (URL) to generate the authorization objects.

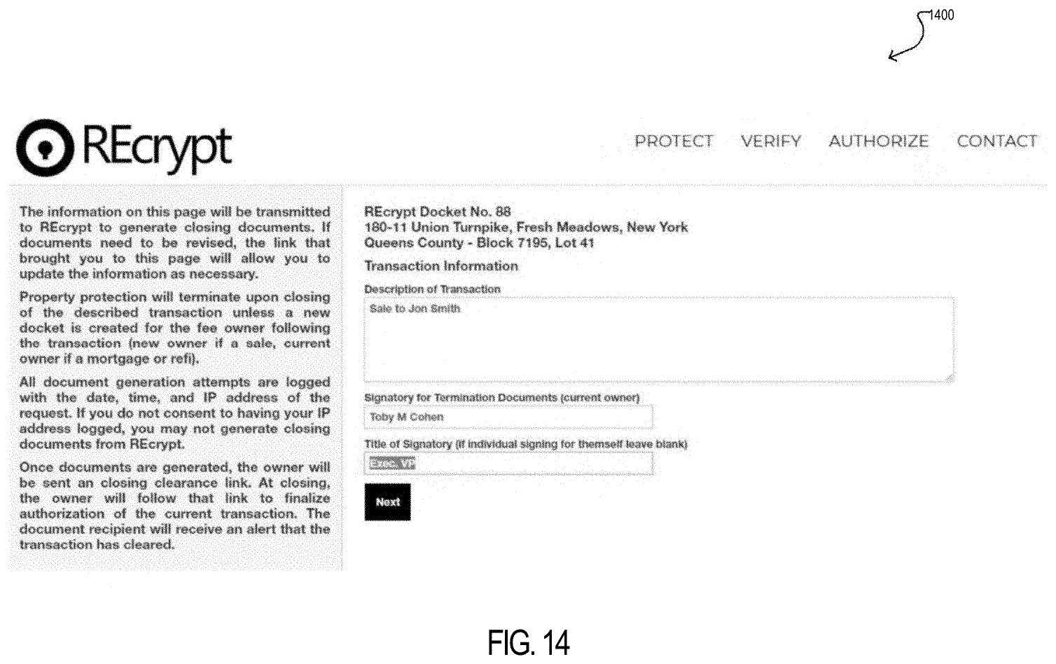

FIG. 14 illustrates a screenshot 1400 of an example graphical user interface according to an example of the instant disclosure. As shown in FIG. 14, the user may provide information such as a description of the transfer request, e.g., “Sale to Jon Smith”, at least one signatory for termination objects, and a title of the at least one signatory, among other information.

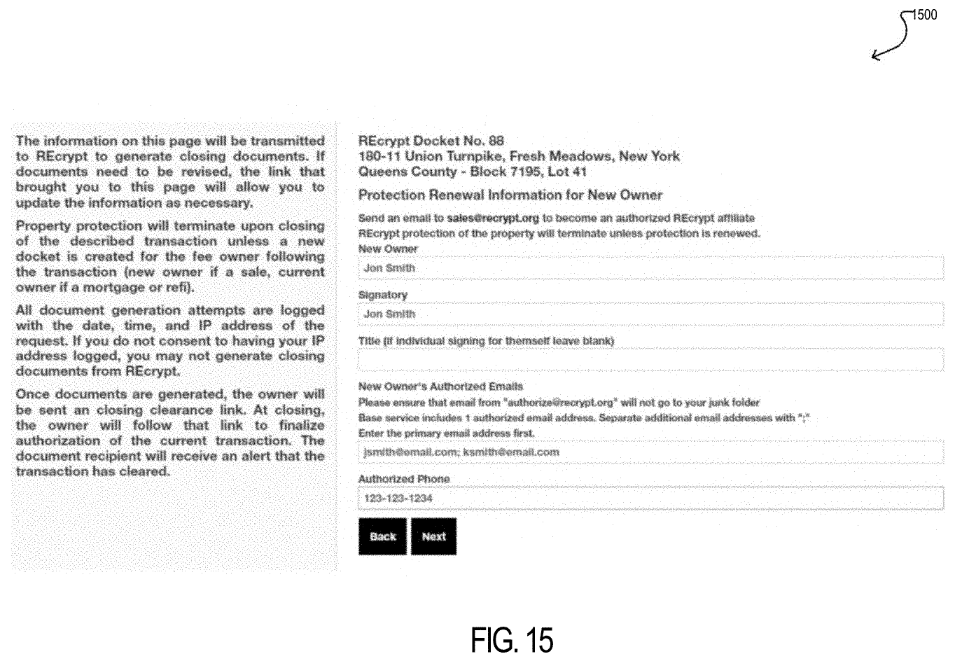

FIG. 15 illustrates a screenshot 1500 of an example graphical user interface according to an example of the instant disclosure. As shown in FIG. 15, the user may provide information associated with a new user (e.g., owner) of the physical location including a name of a new user of the physical location, at least one signatory for the physical location, a title for the new user of the physical location, at least one authorized communication address, and an alphanumeric communication identifier, among other information.

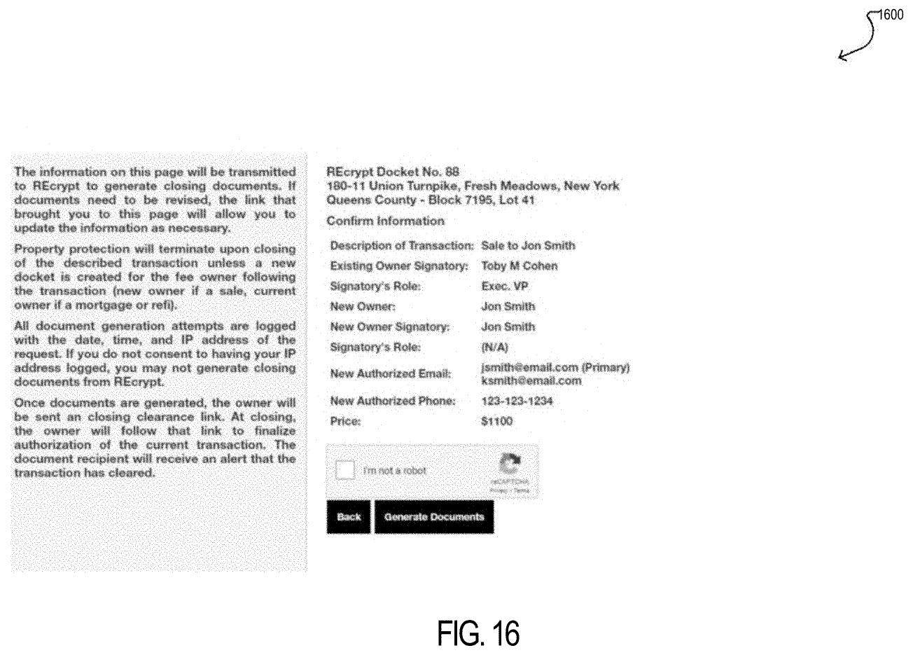

FIG. 16 illustrates a screenshot 1600 of an example graphical user interface according to an example of the instant disclosure. As shown in FIG. 16, the server computing device 104 may receive information associated with the transfer and display the information for confirmation by the user of the client computing device 102.

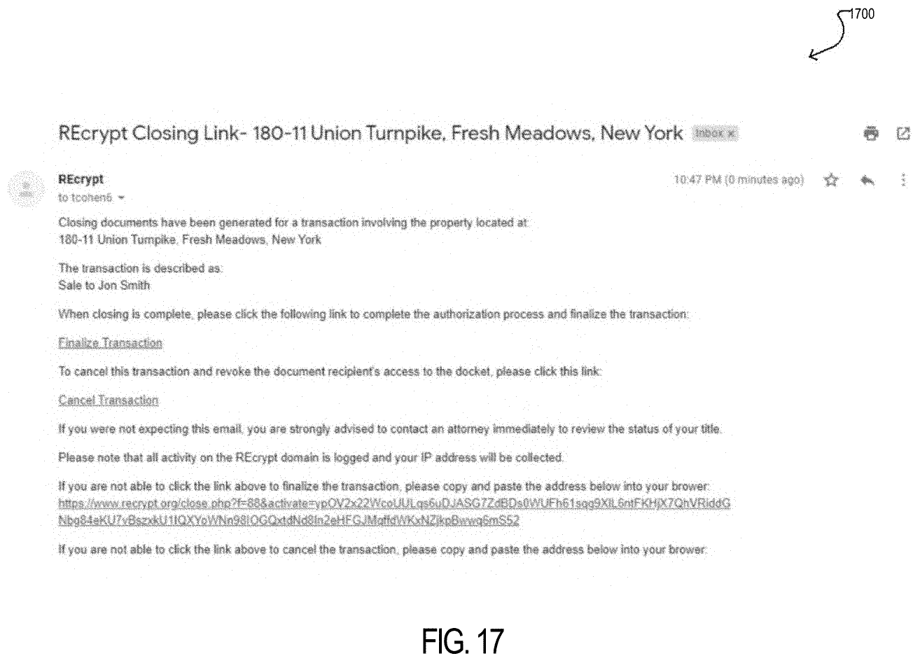

FIG. 17 illustrates a screenshot 1700 of an example graphical user interface according to an example of the instant disclosure. FIG. 17 shows an example communication associated with the transfer of the physical location. The communication may include a first uniform resource locator (URL) associated with finalizing the transfer and a second uniform resource locator (URL) associated with canceling the transfer.

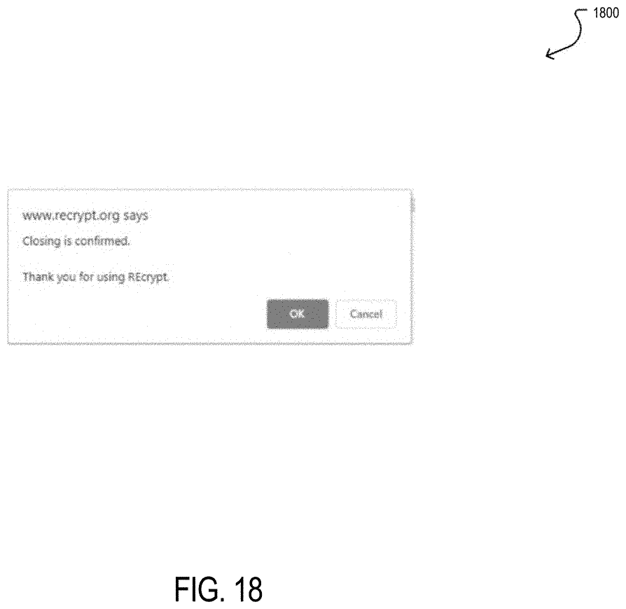

FIG. 18 illustrates a screenshot 1800 of an example graphical user interface according to an example of the instant disclosure. As shown in FIG. 18, when the user selects the URL associated with finalizing the transfer, the client computing device 102 may display a modal user interface element or another user interface element that indicates that the transfer is finalized and a closing is confirmed.

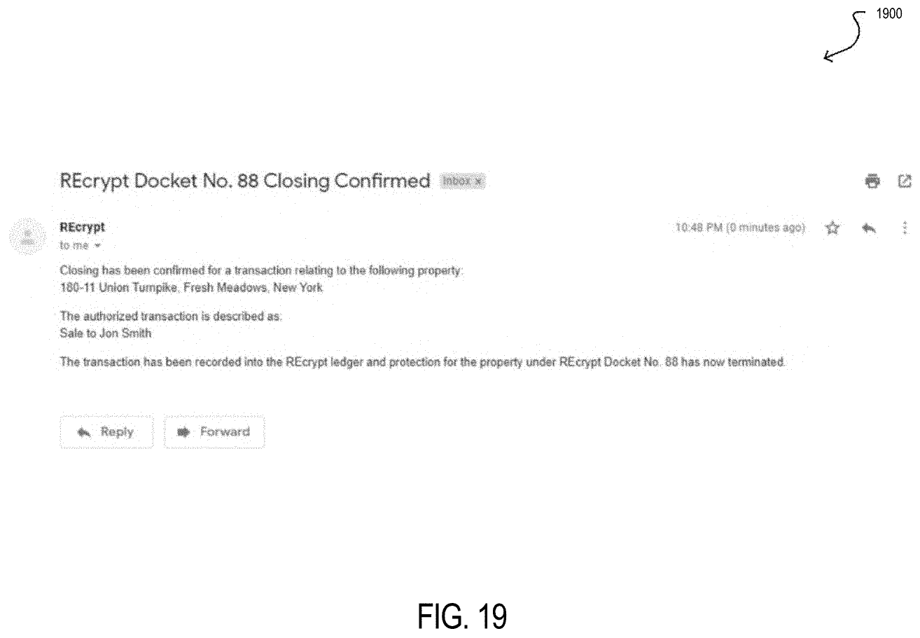

FIG. 19 illustrates a screenshot 1900 of an example graphical user interface according to an example of the instant disclosure. FIG. 19 shows an example communication that may be transmitted when the transfer is finalized that includes information associated with the authorization including the address of the physical location and a description of the transfer, among other information.

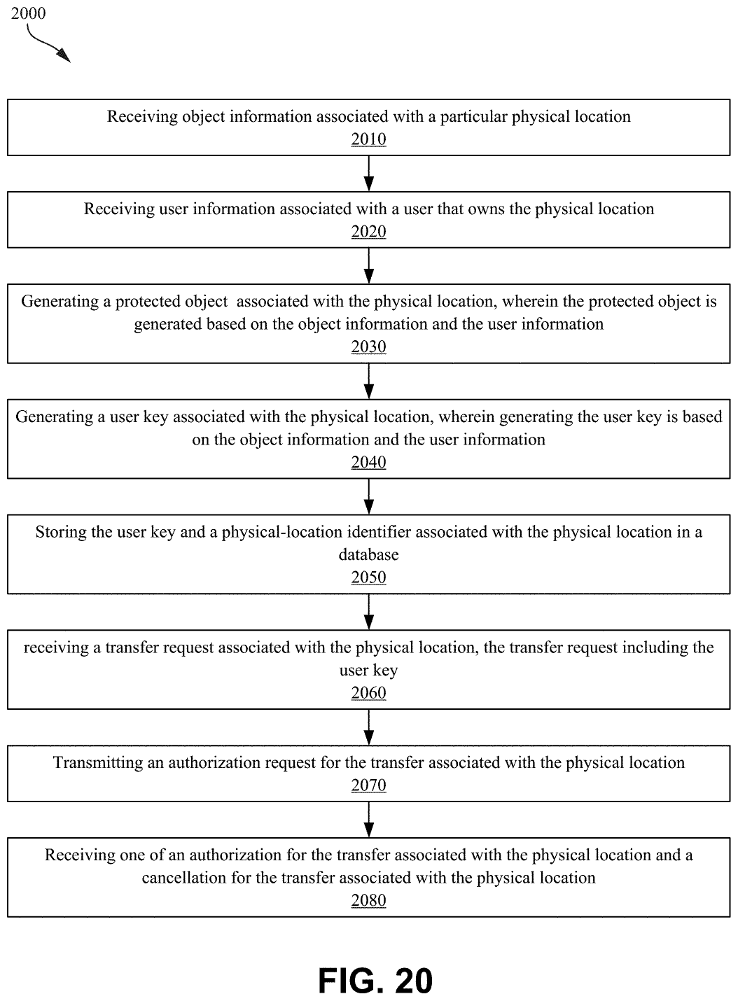

FIG. 20 illustrates a flowchart of an example process 2000 for authorizing a physical location transfer according to aspects of the present disclosure. Although process 2000 depicts a particular sequence of operations, the sequence may be altered without departing from the scope of the present disclosure. For example, some of the operations depicted may be performed in parallel or in a different sequence that does not materially affect the function of the method 2000. In other examples, different components of an example device or system that implements the method 2000 may perform functions at substantially the same time or in a specific sequence.

The method 2000 may include generating a graphical user interface to be displayed by the browser application 110 of the client computing device 102 and transmitting the user interface to the client computing device 102 to be displayed by the browser application 110 of the client computing device.

According to some examples, the method 2000 includes receiving physical-location information associated with a particular physical location at block 2010. The physical-location information may include at least one of a domain (e.g., a state, or the like), a region (e.g., a county, or the like) associated with the domain, block information, lot information, and section information, among other information. The database may have a list of physical locations in the United States, and each physical location in the list of physical locations may be cross-referenced with a domain, a region, and/or an area (e.g., a municipality or the like).

According to some examples, the method 2000 includes receiving user information associated with the particular physical location at block 2020. The user information may include at least one of an user name, at least one signatory for the protected objects, a title for the at least one signatory for the protected object, at least one communication address, and an alphanumeric communication identifier. The at least one communication address may be a primary address that can one of authorize the transfer and cancel the transfer, and can include a secondary address that can cancel the transfer. The protected object may be a protected object and/or transfer objects containing protection strings as shown in the Appendix.

According to some examples, the method 2000 includes generating protected objects associated with the particular physical location based on the physical-location information and the user information at block 2030. The protected objects may include data in a Portable Document Format (PDF) file or may be another format. The method may include receiving resource information that provides an amount of resources from the client computing device 102 and generating the user key and the protected objects. When receiving the resources, physical-location information, and user information, the method may include obtaining an IP address from the client computing device 102 and storing the IP address in the database. In some instances, the IP address may be obtained from communications transmitted to or from the client computing device 102. In other instances, the IP address may be provided by the client computing device 102, another device associated with the client device 102, and/or the like.

According to some examples, the method 2000 includes generating an user key associated with the particular physical location based on the physical-location information and the user information at block 2040. In one example, the user key may be a one-time use one-hundred-and-twenty-eight character alphanumeric key, or another type of key. Generating the user key may include executing one or more cryptographic functions on the combined physical-location information and the user information. In some instances, the user keys bay single use keys. In instances in which multiple user keys may be needed, a set of user keys may be generated using the combined physical-location information and the user information and a random number seed. The random number seed may be used by a random number generated to generate random numbers. A random number may be added to the combined physical-location information and the user to generate a unique user key. A different random number may be added to the combined physical-location information and the user information to generate another user key.

In some examples, the cryptographic function may be a hash function (e.g., MD-5, SHA-3, or the like). In other examples, the cryptographic function may be any function configured to generate an alphanumeric string from a set of data (e.g., physical-location information and the user information, optional random number seed, etc.). The user key may be of any character-length such as 128 characters (as previously disclosed), 256 characters, 64 characters, etc. The webserver may vary the character length based on user input, a detected security risk, a predicted security risk (e.g., via a machine-learning classifier, neural network, or the like), resources available to the webserver (e.g., the character length may be reduced when processing resources are low and increased when additional processing resources are available), combinations thereof, or the like.

According to some examples, the method 2000 includes storing the user key and a physical-location identifier associated with the particular physical location in a database at block 2050. The method may include generating the physical-location identifier associated with the particular physical location and storing the physical-location identifier associated with the particular physical location in the database. The method also may include generating the user key associated with the particular physical location and storing a representation of the user key associated with the particular physical location in the database.

According to some examples, the method 2000 includes receiving a request to initiate a transfer associated with the particular physical location at block 2060. The request may include the user key. The request to initiate the transfer may include receiving description information associated with the transfer associated with the particular physical location, at least one signatory for the authorization object, and a title of the at least one signatory for the authorization object. The request to initiate the transfer may further include receiving a new user name for a new user associated with the particular physical location, at least one signatory for the new user's protected object, at least one communication address for the new user (e.g., a primary communication address and a secondary communication address), and an alphanumeric communication identifier for the new user.

According to some examples, the method 2000 includes transmitting a transfer authorization request for the transfer associated with the particular physical location at block 2070. This may include generating and transmitting a first communication to the primary communication address (e.g., such as email, Internet Protocol, etc.), the first communication having a first uniform resource locator (URL) to allow the authorization approval and a second uniform resource locator (URL) to cancel the transfer. This also may include generating and transmitting a second communication to the secondary address (e.g., such as email, Internet Protocol, etc.), the second communication having the second uniform resource locator (URL) to cancel the transfer.

According to some examples, the method 2000 includes receiving one of an authorization approval for the transfer associated with the particular physical location and a cancellation for the transfer associated with the particular physical location at block 2080.

In one example, the physical-location identifier may be a first physical-location identifier and the user key comprises a first user key. The authorization approval process may include receiving authentication information associated with the transfer associated with the particular physical location, the authentication information comprising a second physical-location identifier associated with the particular physical location, a second user key, and an communication address, comparing the first physical-location identifier with the second physical-location identifier, comparing the first user key with the second user key, and transmitting a communication to the communication address that indicates that the first physical-location identifier matches the second physical-location identifier and the first user key matches the second user key.

As an example, this may include transmitting a finalize transfer request based on the user information associated with the particular physical location. Additionally, the method 2000 may include receiving the authorization approval for the transfer associated with the particular physical location and generating an authorization object based on the authorization approval. As an example, this may include generating the authorization object that includes a Portable Document Format (PDF) file or other file format based on the description information, and at least one signatory for the authorization object. In addition, as an example, the method 2000 may include recording the transfer associated with the physical location in the database. In addition, if the new user desires protection, the method 2000 may further include generating new protected object associated with the particular physical location based on the physical-location information and new user information. The authorization object may be authorization object and/or transfer objects containing authorization strings as shown in the Appendix.

Alternatively, if the transfer is not authorized, the method 2000 may include receiving the cancellation for the transfer associated with the particular physical location and cancelling the transfer associated with the particular physical location.

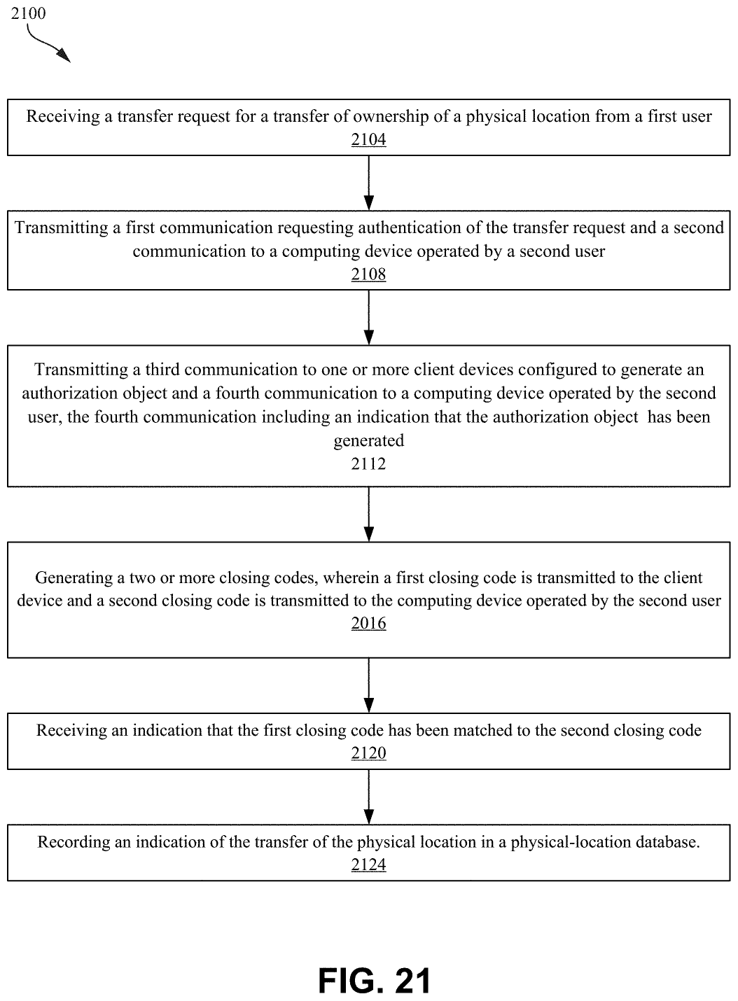

FIG. 21 illustrates a flowchart of another example process for authorizing a physical location transfer according to aspects of the present disclosure. At block 2104, a first computing device may receive a transfer request for a transfer of ownership of a physical location from a first user (e.g., the current owner of the physical location). The first computing device may be a server, processing device, mobile device, and/or the like configured to secure the transfer of physical locations (e.g., real property). The first computing device may communicate with a client device operated by the first user. In some instances, the first computing device may generate and/or facilitate the generation of interfaces configured to enable the user to access services provided by the first computing device. For example, the interfaces may include graphical user interfaces that may generated and/or rendered by an application (e.g., such as a web browser or other application) of the client device. The first user may interact with the interface to initiate a transfer request associated with a physical location associated with the first user.

At block 2108, the first computing device may transmit a first communication requesting authentication of the transfer request. In some instance, the communication may be transmitted to a previously stored location such as, but not limited to, an address of the user (e.g., such an email address, Internet Protocol address, physical address, and/or the like), an alphanumeric connection identifier of the user (e.g., a phone number, or the like), a unique communication identifier associated with the user, and/or the like. the first computing device may transmit a second communication to a client device operated by a second user (e.g., title agent, or the like) that is configured to assist the transfer of the physical location to a new user.

The first computing device may receive a response communication that includes an approval of the authentication request (e.g., approving the transfer of the physical location to the new user) from the client device operated by the first user (or any other device operated by the first user). Alternatively, the first computing device may receive from the client device operated by the first user. A cancellation request which may cause the server to terminate further processing of the transfer request.

At block 2112 in response to receiving the response communication, the first computing device may transmit a third communication and a fourth communication associated with an authorization object. The third communication may be transmitted to one or more client devices configured to generate the authorization object (e.g., a data structure, database, document, documentation, etc.). The one or more computing devices may include the client device operated by the first user, computing devices operated by agents of the first user, computing devices identified by the first user, and/or the like. The third communications may be transmitted to an Internet Protocol address (e.g., directly and/or indirect messaging), email, or the like. The third communication may include instructions (e.g., such as a uniform resource locator, or the like), that may be executed by the receiving computing device. When executed, the instructions may cause the generation of the authorization object. The authorization object may be generated at the computing device that executing the instructions or by another device (e.g., the first computing device or a different computing device). Once generated, the authorization object may be transmitted to and/or stored by the computing device that executing the instructions, transmitted to and/or stored by the client device operated by the first device, transmitted to and/or stored by the first computing device, transmitted to and/or stored by a database, transmitted to and/or stored by another device, and/or the like.

The fourth communication may be transmitted to a computing device operated by the second user and include an indication that generation of the authorization object is to be initiated, is in progress, and/or has been completed. In some instances, the indication that generation of the authorization object is to be initiated, is in progress, and/or has been completed, may be transmitted to one or more other devices such as, but not limited to the computing device operated by the first user, a computing device identified by the first user and/or the second user, the remote device, and/or the like.

In some instances, the instructions transmitted to a device for execution by the device (e.g., such as the instructions included in the third communication, etc.), may be encrypted to prevent unauthorized execution of the instructions. Each authorization attempt may be associated with a unique identifier generated by the first computing device. The unique identifier may be an alphanumeric string generated using a dataset derived from transfer request, the first user, characteristics of the physical location, the user that is to receive the physical location, and/or the like. Since multiple transfer requests may be generated for a same dataset, generating the unique identifier may also be based on a random number seed. The combine dataset and random number seed may ensure multiple alpha number strings can be generated for a same dataset. In some examples, the unique dataset may be generated by generating a hash value (e.g., MAD, SHA-3, etc.) from the dataset, concatenating the hash value with the random number seed, and extracting a predetermined quantity of alphanumeric characters from the concatenated hash value and random number seed. In other examples, the unique dataset may be generated by generating a hash value from a combined dataset and random number seed. In still yet other examples, other processes may be executed that may generate multiple unique identifiers from a dataset.

The first computing device may generate single use encrypted strings that correspond to each unique identifier. The encrypted string may be generated using the unique identifier (e.g., which itself may be used once for each transfer request), the dataset or portions thereof, the objects generated from the dataset, and/or the like. In some instances, the encrypted strings may be embedded into the instructions. For example, the unique identifier and the encrypted string may be embedded into uniform resource locator (e.g. “page.php?transctionid=12345&code=128 character sha256 encrypted string”, where the transfer id corresponds to the unique identifier, and the code may correspond to the encrypted string. The instructions may be executed by transmitting data to the device (e.g., webserver, first computing device, etc.) located by the uniform resource locator. The first computing device may wait until data at the uniform resource location is received. When data is received, the first computing device may continue processing the transfer request (e.g., generating appropriate objects, etc.) and delete the uniform resource location. Since the encrypted passwords are intended to be single use, the first computing device may not accept data received at the location of the uniform resource locator.

The instructions including the unique identifier and/or encrypted string may be generated by the first computing device and transmitted to the client device. Alternatively, the instructions may be transmitted without the unique identifier and/or encrypted string. The client device may generate the unique identifier and/or encrypted string based on a predetermined process known to the first computing device (e.g., based on the dataset, the physical location, etc.). In those instances, the client device may be configured to generate a same sequence of unique identifiers and one-time encrypted strings from a same dataset as the first computing device. The client device may store an indication of each transfer request to enable embedding the correct unique identifier and/or encrypted string into the instructions.

In other instances, the encrypted string may be used to decrypt the instructions. The client device may receive the encrypted string with the third communication or in a separate communication (e.g., similar to two-factor authentication processes). The encrypted string may be used to decrypt the instructions enabling the client device to execute the instructions to continue the process (e.g., generating the authentication object, etc.). Once execution of the instructions is detected by the first device, (e.g., a request for generating the authentication object is received), deny future requests to generate authentication objects (e.g., associated with a same unique identifier, etc.).

At block 2116, in response to determining that the authorization object has been generated, the first computing device may generate a matching set of closing codes. The first computing device then transmits a fifth communication to the client device operated by the first user. The fifth communication may include a first closing code from the set of matching closing codes, instructions executable to complete the transfer request (with a same unique identifier and a different encrypted string), and optionally, a instructions executable to cancel the transfer request. The first computing device also transmits a sixth communication to the device operated by the second user. The sixth communication may include, the matching closing code from the set of matching closing codes, instructions executable to complete the transfer request (e.g., with the same unique identifier and a different encrypted string).

At block 2120, the closing code transmitted to the client device operated by the first user may be matched to the closing code transmitted to the client device operated by the second user. In some instances, an independent computing device (e.g., the first computing device, another device, etc.) may be used to match the two closing codes. In those instances, the client device the client device operated by the first user and the client device operated by the second user may each transmit the respective closing codes to the independent computing device. The independent computing device may verify that that the closing codes match and transmit an indication of the match to the client device operated by the first user and/or the client device operated by the second user. If the closing codes do not match, the independent computing device may transmit a communication to the first computing device terminating the transfer request. Upon being received, the first computing device may delete any unique identifiers, single use encrypted strings, closing codes and/or the like.

In other instances, the second user may verify that the closing codes match. In those instances, the client device operated by the first user may transmit its closing code to the client device operated by the second user. Alternatively, the first user may transmit the closing code received by the client device operated by the first user (e.g., over a phone connection, in person, via another device, and/or the like).

Once it is determined that the two closing codes match, the first user and the second user may complete the transfer request (e.g., authorizing the transfer request).

At block 2124, once the first user and the second user complete the transfer request for a particular unique identifier, the transfer may be recorded by a physical location database. Recording the transfer may include terminating a protected object associated with physical object (the protected object preventing transfers request from being completed), modifying a dataset of the physical location database associated with physical location by storing a closing code of the matching set of closing codes in associated with the dataset, and storing an indication that the transfer request was authorized (e.g., by the first user and the second user) and that the protected object is terminated.

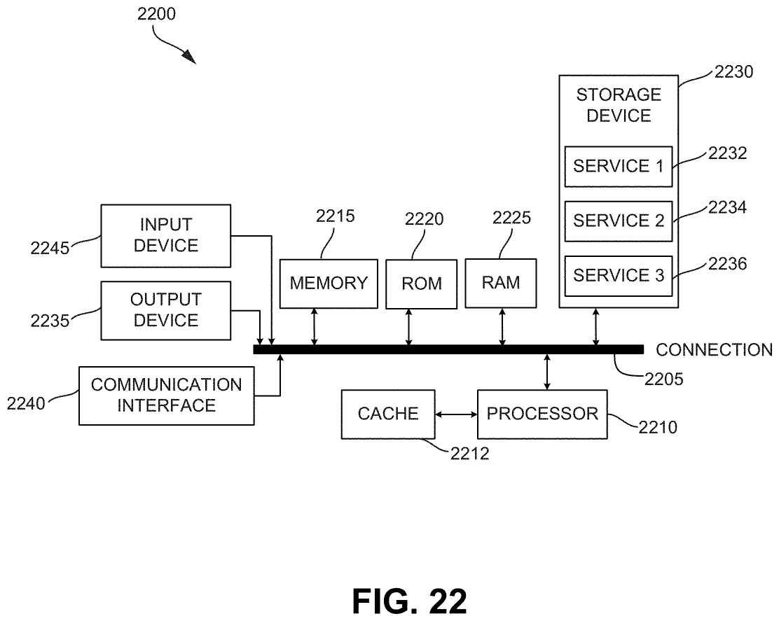

FIG. 22 illustrates an example computing device architecture of an example computing device that can implement the various techniques described herein according to aspects of the present disclosure. Example computing device 2200 may be, for example, any computing device making up the client computing device 102, the server computing device 104, or any component thereof in which the components of the system are in communication with each other using connection 2205. Connection 2205 can be a physical connection via a bus, or a direct connection to processor 2210, such as in a chipset architecture. Connection 2205 can also be a virtual connection, networked connection, or logical connection.

In some embodiments, computing system 2200 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 2200 includes at least one processing unit (CPU or processor) 2210 and connection 2205 that couples various system components including system memory 2215, such as read-only memory (ROM) 2220 and random access memory (RAM) 2225 to processor 2210. Computing system 2200 can include a cache of high-speed memory 2212 connected directly with, in close proximity to, or integrated as part of processor 2210. Processor 2210 can include any general purpose processor and a hardware service or software service, such as services 2232, 2234, and 2236 stored in storage device 2230, configured to control processor 2210 as well as a special-purpose processor where software instructions are incorporated into the actual processor design. Processor 2210 may essentially be a completely self-contained computing system, containing multiple cores or processors, a bus, memory controller, cache, etc. A multi-core processor may be symmetric or asymmetric.

To enable user interaction, computing system 2200 includes an input device 2245, which can represent any number of input mechanisms, such as a microphone for speech, a touch-sensitive screen for gesture or graphical input, keyboard, mouse, motion input, speech, etc. Computing system 2200 can also include output device 2235, which can be one or more of a number of output mechanisms known to those of skill in the art. In some instances, multimodal systems can enable a user to provide multiple types of input/output to communicate with computing system 2200. Computing system 2200 can include communications interface 2240, which can generally govern and manage the user input and system output. There is no restriction on operating on any particular hardware arrangement, and therefore the basic features here may easily be substituted for improved hardware or firmware arrangements as they are developed.

Storage device 2230 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 2230 can include software services, servers, services, etc., that when the code that defines such software is executed by the processor 2210, it causes the system to perform a function. In some embodiments, a hardware service that performs a particular function can include the software component stored in a computer-readable medium in connection with the necessary hardware components, such as processor 2210, connection 2205, output device 2235, etc., to carry out the function.

Additional detail regarding the system 100 is provided in the attached Appendix, which is incorporated herein by reference. In particular, the Appendix includes examples of authorization objects and protected object.

Illustrative examples of the disclosure include:

Aspect 1: A method comprising: receiving, by at least one processor, object information associated with a particular physical location; receiving, by the at least one processor, user information associated with a user that owns the physical location; generating, by the at least one processor, a protected object associated with the physical location, wherein the protected object is generated based on the object information and the user information; generating, by the at least one processor, a user key associated with the physical location, wherein generating the user key is based on the object information and the user information; storing, by the at least one processor, the user key and a physical-location identifier associated with the physical location in a database; receiving, by the at least one processor, a transfer request associated with the physical location, the transfer request including the user key; transmitting, by the at least one processor, an authorization request for the transfer associated with the physical location; and receiving, by the at least one processor, one of an authorization for the transfer associated with the physical location and a cancellation for the transfer associated with the physical location.

Aspect 2: The method of Aspect 1, further comprising: receiving the authorization for the transfer associated with the physical location and generating an authorization object based on the authorization.

Aspect 3: The method of Aspects 1 and 2, further comprising: receiving a description associated with the transfer associated with the physical location, at least one signatory for the authorization object, and a title of the at least one signatory for the authorization object.

Aspect 4: The method of any of Aspects 1 to 3, further comprising: receiving a new user name for a new user associated with the physical location, at least one signatory for the authorization object, at least one address for the new user, and an alphanumeric connection identifier for the new user.

Aspect 5: The method of any of Aspects 1 to 4, further comprising: generating the authorization object includes a Portable Document Format file or other file format based on the description, the at least one signatory for a new protected object, and the at least one signatory for the authorization object.

Aspect 6: The method of any of Aspects 1 to 5, further comprising: transmitting a finalize-request request based on the user information associated with the physical location.

Aspect 7: The method of any of Aspects 1 to 6, further comprising storing: the finalize-request associated with the physical location in the database.

Aspect 8: The method of any of Aspects 1 to 7, further comprising: receiving the cancellation for the transfer associated with the physical location and terminating the transfer request associated with the physical location.

Aspect 9: The method of any of Aspects 1 to 8, wherein the object information comprises at least one of a state, a county associated with the state, block information, lot information, and section information.

Aspect 10: The method of any of Aspects 1 to 9, wherein the user information comprises at least one of an user identifier, at least one signatory for the protected object, a title for at least one signatory for the protected object, at least one address, and an alphanumeric connection identifier.

Aspect 11: The method of any of Aspects 1 to 10, wherein the at least one address comprises a primary communication address that can authorize the request or cancel the transfer request, and a secondary communication address that can cancel the transfer request.

Aspect 12: The method of any of Aspects 1 to 11, further comprising: generating and transmitting a first communication to the primary communication address, the first communication including a link that when executed, causes the authorization and a second link that when executed terminates the transfer request.

Aspect 13: The method of any of Aspects 1 to 12, further comprising generating and transmitting a second communication to the secondary communication address, the second including the second link.

Aspect 14: The method of any of Aspects 1 to 13, further comprising: generating a graphical user interface; and transmitting the graphical user interface to a computing device for be displayed by an application of the computing device.

Aspect 15: The method of any of Aspects 1 to 14, further comprising: generating the physical-location identifier associated with the physical location and storing the physical-location identifier associated with the physical location in the database.

Aspect 16: The method of Aspects 1 to 15, further comprising: generating the user key associated with the physical location and storing a representation of the user key associated with the physical location in the database.

Aspect 17: The method of any of Aspects 1 to 16, wherein the physical-location identifier comprises a first physical-location identifier and the user key comprises a first user key, and wherein the method further comprises: receiving authentication information associated with the transfer request associated with the physical location, the authentication information comprising a second physical-location identifier associated with the physical location, a second user key, and an address; comparing the first physical-location identifier with the second physical-location identifier; comparing the first user key with the second user key; and transmitting a communication to the address that indicates that the first physical-location identifier matches the second physical-location identifier and the first user key matches the second user key.

Aspect 18: The method of any of Aspects 1 to 17, wherein the database comprises a set of physical locations in the within a particular geographical area.

Aspect 19: The method of any of Aspects 1 to 18, wherein each physical location in the set of physical locations is cross-referenced with a domain within the particular geographical area, a region within the domain, and an area within the region.

Aspect 20: The method of any of Aspects 1 to 19, further comprising generating a new protected object associated with the physical location based on the object information and new user information.

Aspect 21: The method of any Aspects 1 to 20, wherein the user key comprises a one-time use one-hundred-and-twenty-eight character alphanumeric key.

Aspect 22: The method of any Aspects 1 to 21, wherein the protected object includes a Portable Document Format or other file format.

Aspect 23: The method of any Aspects 1 to 22, further comprising: receiving resource-allocation information from a computing device; and generating the user key and the protected object.

Aspect 24: The method of any Aspects 1 to 23, further comprising: receiving an Internet Protocol address from a computing device and storing the Internet Protocol address in the database.

Aspect 25: A system comprising: one or more processors; and a non-transitory computer-readable storage medium, having instructions stored thereon that when executed by the one or more processors, cause the one or more processors to perform operations including: receiving object information associated with a particular physical location; receiving user information associated with a user that owns the physical location; generating a protected object associated with the physical location, wherein the protected object is generated based on the object information and the user information; generating a user key associated with the physical location, wherein generating the user key is based on the object information and the user information; storing the user key and a physical-location identifier associated with the physical location in a database; receiving a transfer request associated with the physical location, the transfer request including the user key; transmitting an authorization request for the transfer associated with the physical location; and receiving one of an authorization for the transfer associated with the physical location and a cancellation for the transfer associated with the physical location.

Aspect 26: The system of Aspect 25, wherein the operations further include any Aspects 2 to 23.

Aspect 27: A non-transitory computer-readable storage medium, having instructions stored thereon that when executed by the one or more processors, cause the one or more processors to perform operations including: receiving object information associated with a particular physical location; receiving user information associated with a user that owns the physical location; generating a protected object associated with the physical location, wherein the protected object is generated based on the object information and the user information; generating a user key associated with the physical location, wherein generating the user key is based on the object information and the user information; storing the user key and a physical-location identifier associated with the physical location in a database; receiving a transfer request associated with the physical location, the transfer request including the user key; transmitting an authorization request for the transfer associated with the physical location; and receiving one of an authorization for the transfer associated with the physical location and a cancellation for the transfer associated with the physical location.

Aspect 28: The non-transitory computer-readable storage medium of Aspect 27, wherein the operations further include any Aspects 2 to 23.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored in a form that excludes carrier waves and/or electronic signals. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Some portions of this description describe examples in terms of algorithms and symbolic representations of operations on information. These operations, while described functionally, computationally, or logically, may be implemented by computer programs or equivalent electrical circuits, microcode, or the like. Furthermore, arrangements of operations may be referred to as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module can be implemented with a computer-readable medium storing computer program code, which can be executed by a processor for performing any or all of the steps, operations, or processes described.

Some examples may relate to an apparatus or system for performing any or all of the steps, operations, or processes described. The apparatus or system may be specially constructed for the required purposes, and/or it may comprise a general-purpose computing device selectively activated or reconfigured by a computer program stored in memory of computing device. The memory may be or include a non-transitory, tangible computer readable storage medium, or any type of media suitable for storing electronic instructions, which may be coupled to a bus. Furthermore, any computing systems referred to in the specification may include a single processor or multiple processors.

While the present subject matter has been described in detail with respect to specific examples, it will be appreciated that those skilled in the art, upon attaining an understanding of the foregoing, may readily produce alterations to, variations of, and equivalents to such embodiments. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art.

For clarity of explanation, in some instances the present disclosure may be presented as including individual functional blocks including functional blocks comprising devices, device components, steps or routines in a method embodied in software, or combinations of hardware and software. Additional functional blocks may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual examples may be described herein as a process or method which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not shown. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

Devices implementing the methods and systems described herein can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. The program code may be executed by a processor, which may include one or more processors, such as, but not limited to, one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A processor may be a microprocessor; conventional processor, controller, microcontroller, state machine, or the like. A processor may also be implemented as a combination of computing components (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein. Functionality described herein also can be embodied in peripherals or add-in cards. Such functionality can also be implemented on a circuit board among different chips or different processes executing in a single device, by way of further example.

In the foregoing description, aspects of the disclosure are described with reference to specific examples thereof, but those skilled in the art will recognize that the disclosure is not limited thereto. Thus, while illustrative examples of the disclosure have been described in detail herein, it is to be understood that the inventive concepts may be otherwise variously embodied and employed, and that the appended claims are intended to be construed to include such variations. Various features and aspects of the above-described disclosure may be used individually or in any combination. Further, examples can be utilized in any number of environments and applications beyond those described herein without departing from the broader spirit and scope of the disclosure. The disclosure and figures are, accordingly, to be regarded as illustrative rather than restrictive.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or media devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method comprising:
receiving a transfer request associated with an authorization corresponding to a physical location, wherein the authorization is associated with a first computing device;
transmitting, in response to receiving the transfer request, a first communication requesting authentication of the transfer request and a second communication to a second computing device configured to process a portion of the transfer request;
transmitting a third communication to one or more client device configured to generate an authorization object in response to receiving a response to the first communication that includes an indication that the transfer request is authentic, wherein the one or more client devices include the second computing device;
generating two or more access codes, wherein a first access code of the two or more access codes is configured for transmission to the one or more client devices and a second access code of the two or more access codes is configured to be transmitted to the first computing device;
receiving an indication that the first access code matches the second access code, wherein the indication is based on communication from the first computing device and the one or more client devices; and
executing the transfer request, wherein executing the transfer request includes storing an indication of a transfer associated with the physical location in a physical-location database.

2. The method of claim 1, wherein the authentication object includes a physical-location identifier and a user key.

3. The method of claim 1, wherein the first communication is transmitted to a different address than an address of the first computing device.

4. The method of claim 1, wherein executing the transfer request includes:
terminating a protected object that prevents transfer requests.

5. The method of claim 1, wherein the transfer requests includes user information associated with a user of the first computing device, wherein the user information includes at least one of an user identifier, at least one signatory for a protected object, a title for at least one signatory for a protected object, at least one address, and an alphanumeric connection identifier.

6. The method of claim 1, wherein the third communication includes encrypted instructions configured for execution by the one or more client devices to execute the transfer request, the encrypted instructions including a single use code generated from the transfer request.

7. The method of claim 6, wherein the encrypted instructions include a single use code embedded therein.

8. A non-transitory computer-readable storage medium, having instructions stored thereon that, when executed by at least one computing device cause the at least one computing device to perform operations including:
receiving a transfer request associated with an authorization corresponding to a physical location, wherein the authorization is associated with a first computing device;
transmitting, in response to receiving the transfer request, a first communication requesting authentication of the transfer request and a second communication to a second computing device configured to process a portion of the transfer request;
transmitting a third communication to one or more client device configured to generate an authorization object in response to receiving a response to the first communication that includes an indication that the transfer request is authentic, wherein the one or more client devices include the second computing device;
generating two or more access codes, wherein a first access code of the two or more access codes is configured for transmission to the one or more client devices and a second access code of the two or more access codes is configured to be transmitted to the first computing device;
receiving an indication that the first access code matches the second access code, wherein the indication is based on communication from the first computing device and the one or more client devices; and
executing the transfer request, wherein executing the transfer request includes storing an indication of a transfer associated with the physical location in a physical-location database.

9. The non-transitory computer-readable storage medium of claim 8, wherein the authentication object includes a physical-location identifier and a user key.

10. The non-transitory computer-readable storage medium of claim 8, wherein the first communication is transmitted to a different address than an address of the first computing device.

11. The non-transitory computer-readable storage medium of claim 8, wherein executing the transfer request includes:
terminating a protected object that prevents transfer requests.

12. The non-transitory computer-readable storage medium of claim 8, wherein the transfer requests includes user information associated with a user of the first computing device, wherein the user information includes at least one of an user identifier, at least one signatory for a protected object, a title for at least one signatory for the protected object, at least one address, and an alphanumeric connection identifier.

13. The non-transitory computer-readable storage medium of claim 8, wherein the third communication includes encrypted instructions configured for execution by the one or more client devices to execute the transfer request.

14. The non-transitory computer-readable storage medium of claim 13, wherein the encrypted instructions include a single use code embedded therein.

15. A system comprising;
a processor; and
a non-transitory computer-readable storage medium, having instructions stored thereon that, when executed by at least one computing device cause the at least one computing device to perform operations including:
receiving a transfer request associated with an authorization corresponding to a physical location, wherein the authorization is associated with a first computing device;
transmitting, in response to receiving the transfer request, a first communication requesting authentication of the transfer request and a second communication to a second computing device configured to process a portion of the transfer request;
transmitting a third communication to one or more client device configured to generate an authorization object in response to receiving a response to the first communication that includes an indication that the transfer request is authentic, wherein the one or more client devices include the second computing device;
generating two or more access codes, wherein a first access code of the two or more access codes is configured for transmission to the one or more client devices and a second access code of the two or more access codes is configured to be transmitted to the first computing device;
receiving an indication that the first access code matches the second access code, wherein the indication is based on communication from the first computing device and the one or more client devices; and
executing the transfer request, wherein executing the transfer request includes storing an indication of a transfer associated with the physical location in a physical-location database.

16. The system of claim 15, wherein the authentication object includes a physical-location identifier and a user key.

17. The system of claim 15, wherein the first communication is transmitted to a different address than an address of the first computing device.

18. The system of claim 15, wherein executing the transfer request includes:
terminating a protected object that prevents transfer requests.

19. The system of claim 15, wherein the third communication includes encrypted instructions configured for execution by the one or more client devices to execute the transfer request.

20. The system of claim 19, wherein the encrypted instructions include a single use code embedded therein.
